(19) United States
(12) Patent Application Publication
(10) Pub. No.: US 2026/0177183 A1
(43) Pub. Date: Jun. 25, 2026

(54) MECHANICAL PLUG

(71) Applicant: Petersen Resources, LLC, Fredonia, WI (US)

(72) Inventors: Philip Lundman, Fredonia, WI (US); Henri Kinson, Mequon, WI (US); Trieu Vi-Do, Milwaukee, WI (US); Grant Anderson, Random Lake, WI (US); Alex Dieringer, Random Lake, WI (US); Devon Swartzentruber, West Bend, WI (US); Romie Holl, Fredonia, WI (US)

(21) Appl. No.: 19/426,560

(22) Filed: Dec. 19, 2025

Related U.S. Application Data
(60) Provisional application No. 63/736,124, filed on Dec. 19, 2024.

(51) Int. Cl. F16L 55/11

(52) U.S. Cl. CPC F16L 55/1108

(57) ABSTRACT

A mechanical plug for restricting fluid flow through a conduit. The mechanical plug includes a first plug member, an elongate member coupled to the first plug member, a second plug member received on the elongate member, a wedge, and a gripper. The wedge is received on the elongate member between the first plug and the second plug. The wedge includes a wedge outer wall. The gripper at least partially surrounds the wedge and is moveable both axially along the central axis and radially with respect to the central axis to selectively engage the conduit. The mechanical plug is transitionable between a first state and a second state. In the first state, the mechanical plug is disengaged from the conduit. In the second state, the mechanical plug engages the conduit.

### CROSS-REFERENCE TO RELATED APPLICATION

This application claims priority to U.S. Provisional Patent Application No. 63/736,124, filed on Dec. 19, 2024, the entire content of which is incorporated herein by reference.

### TECHNICAL FIELD

The present disclosure generally pertains to plugs for fluid conduits.

### BACKGROUND

Inflatable plugs are sometimes used for plugging conduits, such as sewer lines, gas lines, or oil pipelines, to permit maintenance, facilitate toxic waste containment, or remove blockages. However, such plugs typically require coupling to fluid lines to facilitate inflation and deflation within conduits or multiple seal actuators for larger and higher-pressure plugs.

### SUMMARY

In one aspect, the present disclosure provides a mechanical plug for restricting fluid flow through a conduit. The mechanical plug comprises a first plug member, an elongate member coupled to the first plug member, a second plug member, a wedge, and a gripper. The elongate member defines a central axis. The second plug member is received on the elongate member and is movable axially along the central axis. The wedge is received on the elongate member between the first plug and the second plug. The wedge includes a wedge outer wall. The gripper at least partially surrounds the wedge and is moveable both axially along the central axis and radially with respect to the central axis to selectively engage the conduit. The gripper includes a gripper outer wall configured to selectively engage the conduit and a gripper inner wall configured to engage the wedge outer wall. The mechanical plug is transitionable between a first state and a second state. In the first state, the mechanical plug is disengaged from the conduit. In the second state, the mechanical plug engages the conduit.

In another aspect, the present disclosure provides a mechanical plug for restricting fluid flow through a conduit. The mechanical plug includes an elongate member defining a central axis, a plug member received on the elongate member, a wedge received on the elongate member, a gripper at least partially surrounding the wedge, and an actuator position on a side of the plug member opposite the gripper. The plug member is moveable axially along the central axis. The wedge includes a wedge outer wall. The gripper is moveable both axially along the central axis and radially with respect to the central axis to selectively engage the conduit. The gripper includes a gripper outer wall configured to selectively engage the conduit and a gripper inner wall configured to engage the wedge outer wall. The actuator is engageable to apply a force to the gripper through the plug member, thereby engaging the gripper outer wall with the conduit.

In another aspect, the present disclosure provides a mechanical plug for restricting flow through a conduit. The mechanical plug includes a first plug member, an elongate member coupled to the first plug member, a second plug member received on the elongate member, a wedge received on the elongate member between the first plug member and the second plug member, a seal carrier received on the elongate member between the first plug member and the wedge, and a seal. The elongate member defines a central axis. The second plug member is moveable axially along the central axis. The seal carrier includes a seal receiving portion and an intermediate portion that protrudes from the seal receiving portion. The seal is received on the seal receiving portion between the intermediate and one of the first plug member and the wedge. The mechanical plug is transitionable between a first state, in which the one of the first plug member and the wedge applies a first axial force on the seal, and a second state, in which the one of the first plug member and the wedge applies a second axial force on the seal that is greater than the first axial force to compress the seal such that the seal engages the conduit.

### BRIEF DESCRIPTION OF THE DRAWINGS

FIG. 1 is a perspective of a mechanical plug according to an embodiment described in the present disclosure.

FIG. 2 is an exploded view of the mechanical plug of FIG. 1.

FIG. 3 is a cross-sectional view of the mechanical plug of FIG. 1 taken along line 3-3.

FIG. 4 is a partially exploded view of a seal carrier and a plurality of seals of the mechanical plug of FIG. 1.

FIG. 5 is a perspective view of a wedge of the mechanical plug of FIG. 1.

FIG. 6A is a perspective view of a gripper of the mechanical plug of FIG. 1.

FIG. 6B is another perspective view of the gripper of the mechanical plug of FIG. 1.

FIG. 6C is a close-up schematic view of a portion of an alternate gripper.

FIG. 6D is a close-up schematic view of a portion of another alternate gripper.

FIG. 6E is a close-up schematic view of a portion of another alternate gripper.

FIG. 7 is a cross-sectional view of the mechanical plug of FIG. 1 in a disengaged state.

FIG. 8 is a cross-sectional view of the mechanical plug of FIG. 1 in an engaged state.

Other aspects of the disclosure will become apparent by consideration of the detailed description and the accompanying drawings.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Embodiments of the invention relate to mechanical plugs. While in a disengaged state, a mechanical plug is insertable into a conduit, such as a sewer line, an oil pipeline, a gas line, or a water main. The mechanical plug may be inserted through a hot tap in the conduit, for example.

In one embodiment, once inserted, an actuator member of the mechanical plug is moveable into an engaged configuration such that the plug is locked into place within the conduit. Once positioned, the plug is adjusted into a compressed configuration for restricting fluid flow through the conduit by compressing an elastomeric seal. Restricting fluid flow permits repair and/or maintenance (e.g., cleaning, patching holes, etc.) to be performed on the conduit. In another embodiment, the mechanical plug is activated from a disengaged configuration to the compressed configuration without a separate engaged configuration.

The mechanical plug may be made of any suitable materials known in the art. For example, the mechanical plug may be primarily made of aluminum, stainless steel, and/or plated steel. The seal of the mechanical plug may be made of an elastomeric material, such as rubber, although the seal material can be suitably chosen based on chemical and temperature requirements. Generally, the materials should be suitable for most size, pressure, temperature, and chemical requirements typically necessary for restricting fluid flow in a conduit, such as a sewer line, an oil pipeline, a gas line, or a water main. Certain components of the mechanical plug could comprise other materials, such as other metals or alloys, other synthetic or natural polymers, a plastic material, a glass material, a ceramic material, a biomaterial, or a composite material.

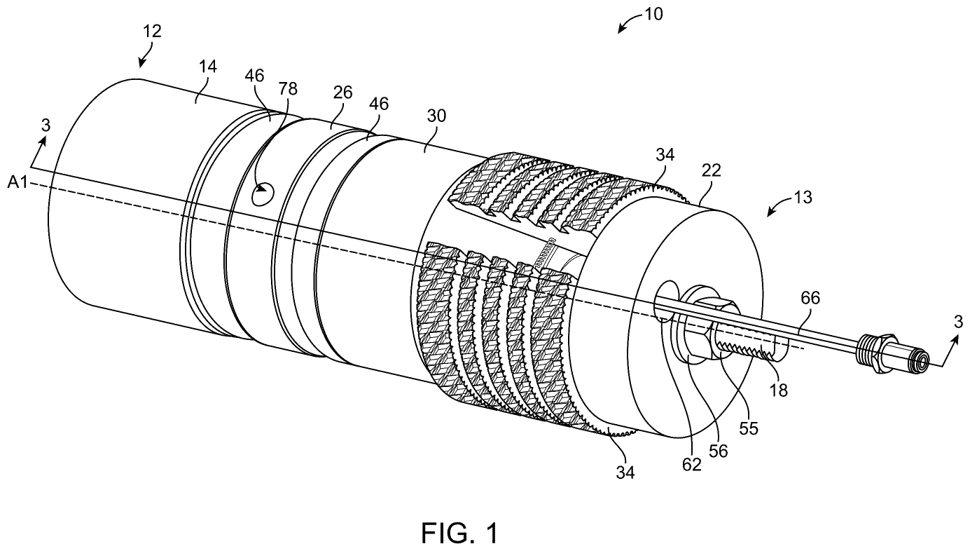

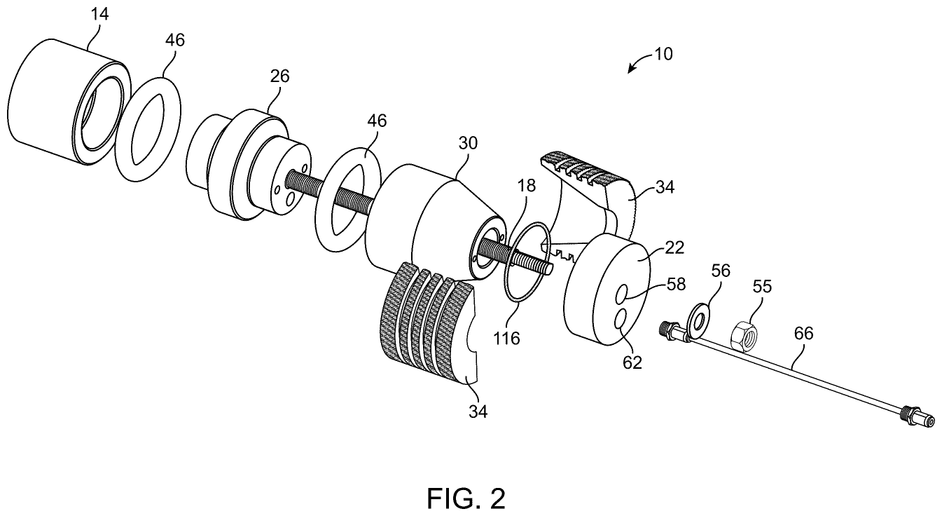

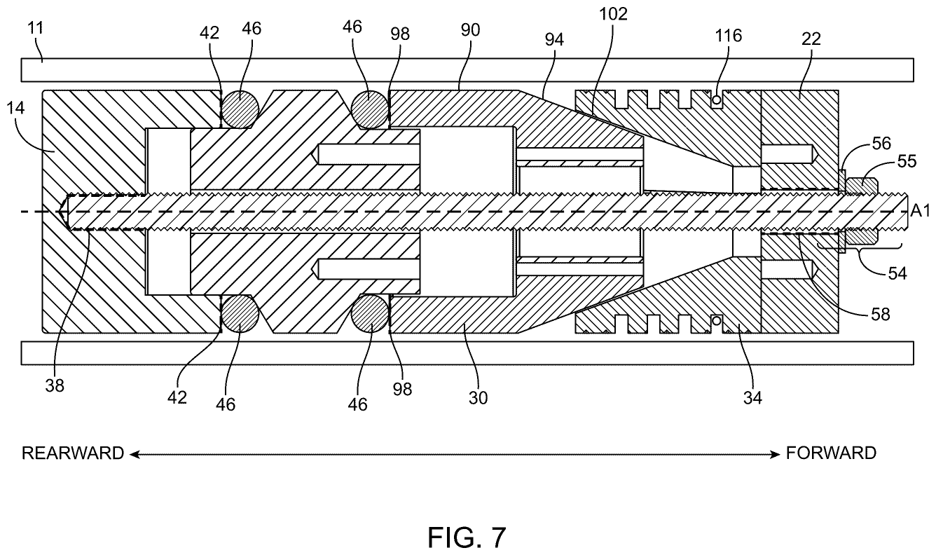

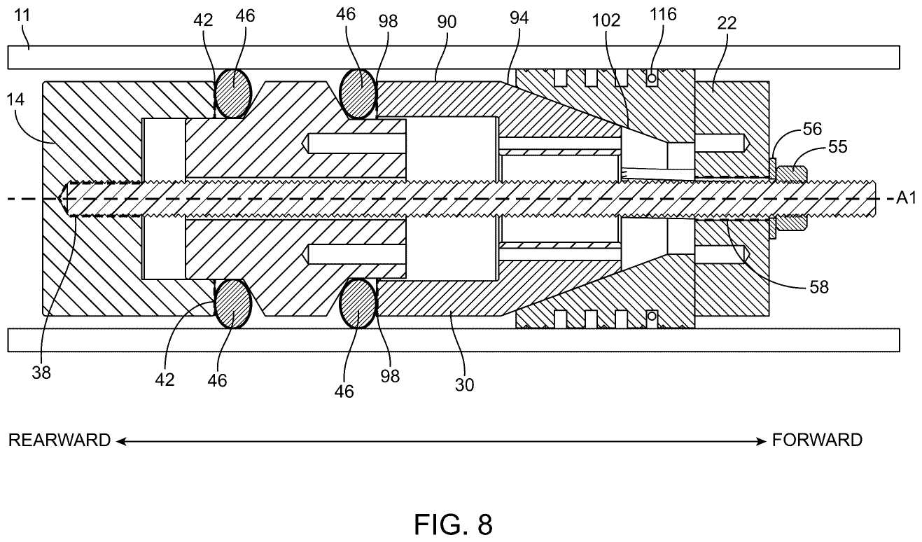

FIGS. 1-3 illustrate a mechanical plug 10 configured to be inserted into a conduit 11 (FIGS. 7 and 8). The mechanical plug 10 is transitionable between a first or disengaged state (FIG. 7), where the mechanical plug 10 does not engage an inner surface of the conduit 11 and is movable or positionable within the conduit 11, and a second or engaged state (FIG. 8), where the mechanical plug 10 engages the inner surface of the conduit 11 and is locked in place relative to the conduit 11. In the disengaged state, the mechanical plug 10 faces a first resistance to motion (e.g., due to fluid flowing through the conduit 11 and/or friction between the mechanical plug 10 and the conduit 11), but allows at least some fluid to flow around the perimeter of the mechanical plug 10. In the engaged state, the mechanical plug 10 faces a second resistance to motion that is greater than the first resistance. In this position, the mechanical plug 10 inhibits or blocks fluid flow in the conduit 11. The mechanical plug 10 defines a first end 12 and a second end 13 opposite the first end 12. The illustrated mechanical plug 10 includes a first plug member 14, an elongate member 18, a second plug member 22, a seal carrier 26, a wedge 30, and a plurality of grippers 34.

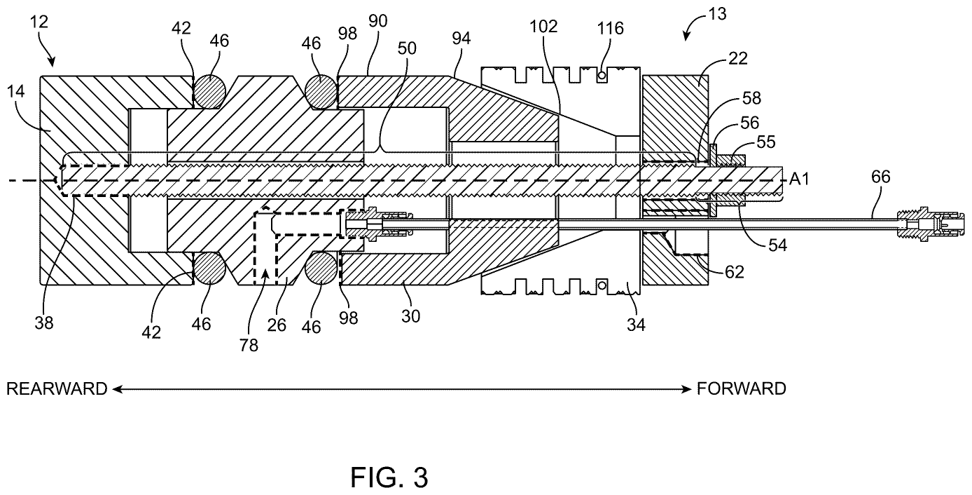

With continued reference to FIGS. 1-3, the first plug member 14 is positioned at the first end 12 of the mechanical plug 10. In the illustrated embodiment, the first plug member 14 has a first plug diameter that is less than an inner diameter of the conduit 11 in which the mechanical plug 10 is installed. The first plug member 14 includes a threaded recess 38 and a first engagement surface 42. As shown in FIG. 3, the threaded recess 38 is formed centrally on the first plug member 14 and extends only partially through the first plug member 14. The threaded recess 38 is configured to receive a portion of the elongate member 18. That is, the threaded recess 38 receives a portion of the elongate member 18 so that the elongate member 18 is coupled to the first plug member 14. The first engagement surface 42 is configured to engage and compress a seal 46, as described in greater detail below.

With continued reference to FIGS. 1-3, the elongate member 18 extends along the length of the mechanical plug 10 and defines a central axis A1. The elongate member 18 may also be referred to as a threaded rod. In the illustrated embodiment, the elongate member 18 has a first threaded portion with a first diameter and a second threaded portion 54 with a second diameter that is less than the first diameter. Also, shown in the illustrated embodiment, the first threaded portion 50 extends along a first length of the elongate member 18, and the second threaded portion 54 extends along a second length along the elongate member 18 less than the first length. In other embodiments, the elongate member 18 may have a constant diameter along its length. The second threaded portion 54 receives a fastener 55 and a washer 56, which are movable along the second length of the second threaded portion 54. In other embodiments, the elongate member 18 may include additional threaded portions and non-threaded portions in addition to the first and second threaded portions 50, 54. In further embodiment, the elongate member 18 may extend completely through the first plug member 14 and include a bypass channel configured to allow fluid to selectively flow between the first and second ends 12, 13 of the mechanical plug 10.

With continued reference to FIGS. 1-3, the second plug member 22 is positioned at the second end of the mechanical plug 10. The second plug member 22 is configured to move axially along the central axis A1 and transfer an axial compressive force onto the wedge 30. In the illustrated embodiment, the axial compressive force is applied by threading the fastener 55 onto the second threaded portion 54 of the elongate member 18. As such, the fastener 55 is positioned on a side of the second plug member 22 opposite the plurality of grippers 34. The washer 56 is positioned between the fastener 55 and the second plug member 22 and increases the area of the second plug member 22 onto which the axial compressive force is applied to. In the illustrated embodiment, the second plug member 22 has a second plug diameter that is less than the inner diameter of the conduit 11 and is substantially similar to the first plug diameter. The second plug member 22 includes a central aperture 58 and a secondary aperture 62 spaced radially from the central aperture 58. In other words, the secondary aperture 62 is spaced radially from a center of the second plug member 22. The central aperture 58 extends through the entire second plug member 22 and is configured to receive the elongate member 18. Additionally, the central aperture 58 is co-axial with the threaded recess 38 of the first plug member 14. The secondary aperture 62 extends through the entire second plug member 22 and is configured to receive part of a bypass assembly 66. Additionally, in the illustrated embodiment, the secondary aperture 62 has a non-constant diameter. In other embodiments, the secondary aperture 62 may have a constant diameter or may be omitted. The bypass assembly 66 is configured to monitor pressure between the seals 46 for seal integrity, vent any fluid that may seep past one of the seals 46, and/or introduce another fluid (e.g., inert gas, water, etc.) between the seals 46.

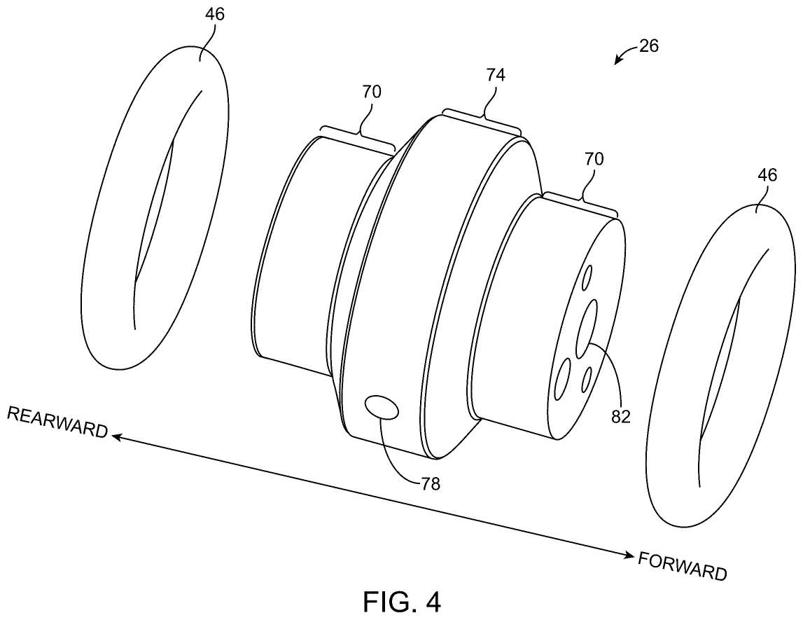

As shown in FIGS. 1-4, the seal carrier 26 is positioned between the first plug member 14 and the second plug member 22. In the illustrated embodiment, the seal carrier 26 is configured to receive and support the seals 46. In the illustrated embodiment, the mechanical plug 10 includes two seals 46. In other embodiments, the mechanical plug 10 may include fewer or more seals 46. The seals 46 are made from an elastomeric material and thus can stretch and deform when a compressive force is applied. In the illustrated embodiment, when a compressive force is applied to the seals 46, the seals 46 expand radially outward to engage an inner surface of the conduit 11, thereby blocking fluid flow through the conduit 11. As shown in FIG. 4, the seal carrier 26 includes a plurality of seal receiving portions 70, an intermediate portion 74, a fluid channel 78, and a central aperture 82. The seal receiving portions 70 are sized to receive the seals 46 and have a reduced diameter compared to the intermediate portion 74. In the illustrated embodiment, the seal carrier 26 includes two seal receiving portions 70 to receive the two seals 46. In other embodiments, the seal carrier 26 may include more or less than two seal receiving portions 70 depending on the number of seals 46. The intermediate portion 74 is located between the seal receiving portions 70. The intermediate portion 74 protrudes from the seal receiving portions 70. The intermediate portion 74 has an intermediate outer diameter that is substantially similar to the first plug diameter and second plug diameter and is larger than outer diameters of the seal receiving portions 70. In the illustrated embodiment, an interface between the intermediate portion 74 and each seal receiving portion 70 is chamfered or ramped. However, in other embodiments, the interface between the intermediate portion 74 and each seal receiving portion 70 may be rounded or may be abrupt (e.g., a 90-degree shoulder). As shown in FIG. 3, the fluid channel 78 extends through the seal carrier 26 and has an inlet, or inlet opening, on the front face of the seal carrier 26 and an outlet, or outlet opening, on the circumferential surface of the intermediate portion 74. In use, the fluid channel 78 is configured to receive a portion of or connect to an end of the bypass assembly 66 at the inlet of the fluid channel 78. The fluid channel 78 creates a fluid connection between a space in front of the second plug member 22 and a volume between the seals 46 on the seal carrier 26. The bypass assembly 66 is configured to place the fluid channel 78 and the space in front of the second plug member 22 in fluid communication with each other. As such, the bypass assembly 66 provides a channel for fluid to travel between the seal carrier 26 and a position external to the mechanical plug 10. The central aperture 82 extends through the seal carrier 26 and is configured to receive the elongate member 18. The central aperture 82 is co-axial with the threaded recess 38 of the first plug member 14.

As shown in FIGS. 1-3 and 5, the wedge 30 is positioned between the first plug member 14 and the second plug member 22. The wedge 30 receives part of one of the seal receiving portions 70 to position and align the wedge 30 relative to the seal carrier 26. In another embodiment, the seal carrier 26 and the wedge 30 may be aligned using at least one pin received in at least one aperture formed in both the seal carrier 26 and at least one aperture formed in the wedge 30. In the illustrated embodiment, the wedge 30 has a central aperture 96 and an outer surface with a cylindrical portion 90, a tapered portion 94, and a second engagement surface 98. The central aperture 96 extends through the entire wedge 30 and is configured to receive both the elongate member 18 and a portion of the wedge 30. The cylindrical portion 90 maintains a first wedge diameter along the entirety of the cylindrical portion 90. In the illustrated embodiment, the first wedge diameter is substantially similar to the first plug diameter and the second plug diameter. The tapered portion 94 has a variable diameter across the length of the tapered portion 94, which defines a taper angle σ. In the illustrated embodiment, the diameter of the tapered portion 94 is at most equal to the first wedge diameter of the cylindrical portion 90, and the diameter of the tapered portion 94 decreases linearly based on a separation distance from the cylindrical portion 90. The shape and taper angle σ of the tapered portion 94 determines the axial and radial movement of the grippers 34 under a compressive axial force. The second engagement surface 98 faces the first engagement surface 42 and is configured to engage and compress one of the seals 46, as described in greater detail below.

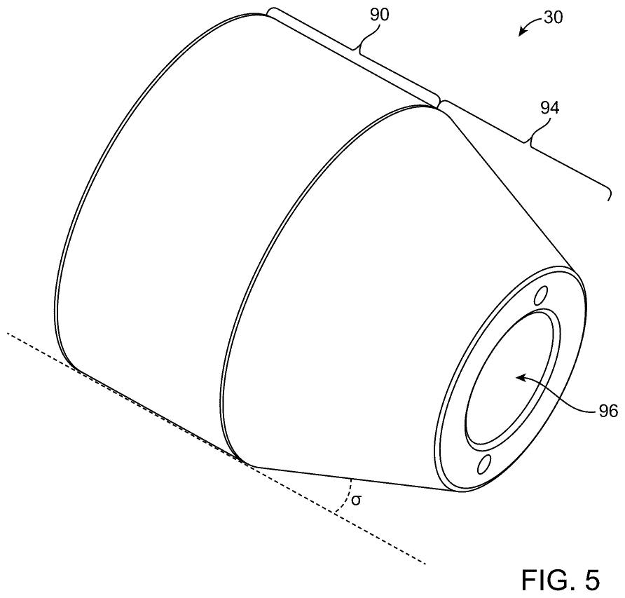

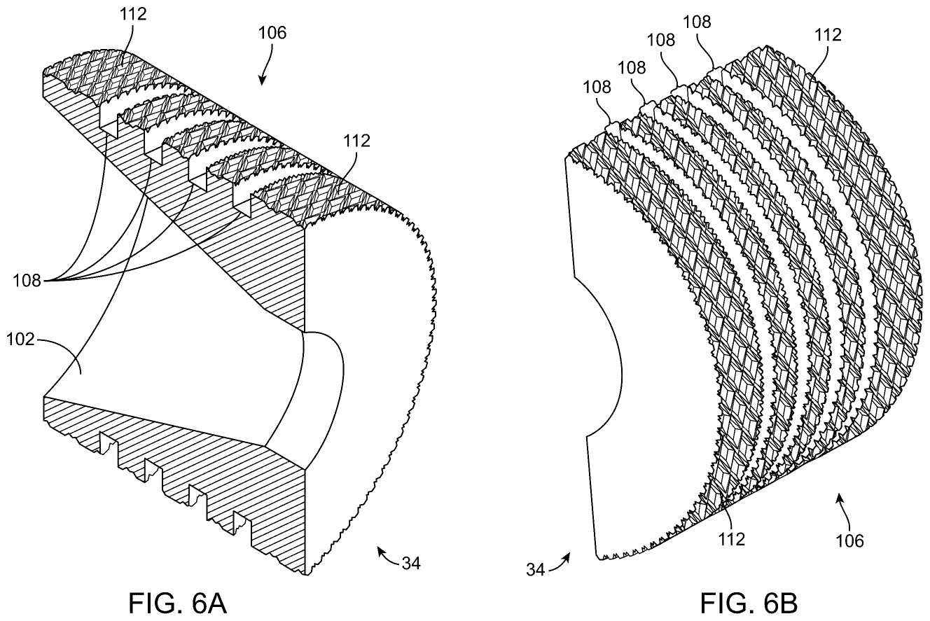

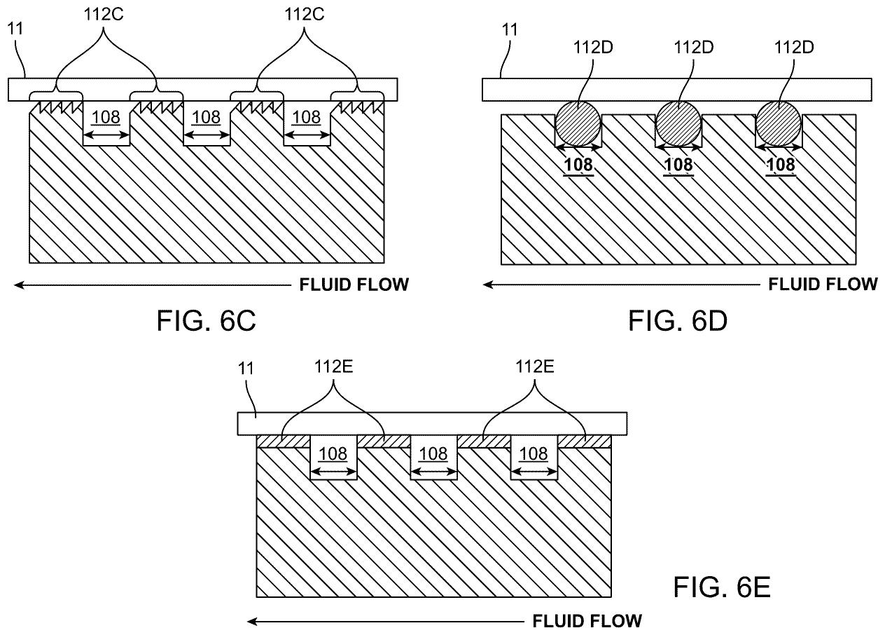

As shown in FIGS. 1-3 and 6A-6B, the plurality of grippers 34 surround the wedge 30 and are positioned between the wedge 30 and the second plug member 22. The plurality of grippers 34 are movable both axially and radially to selectively engage the inner wall of the conduit 11. In the illustrated embodiment, the mechanical plug 10 includes two grippers 34. The grippers 34 are each made of a metallic corrosion resistant material (e.g., anodized aluminum, steel, stainless steel, Monel, Inconel, or Hastelloy). In some embodiments, the grippers 34 undergo a hardening process after machining is complete. In other embodiments, the mechanical plug 10 may include more than two grippers 34. In further embodiments, the grippers 34 may be made of a ceramic material (e.g., aluminum nitride). Each of the grippers 34 includes a gripper inner wall 102 and a gripper outer surface 106. As shown in FIG. 6A, the gripper inner wall 102 has at least a portion with a non-constant diameter along the length of the gripper 34. The gripper inner wall 102 is in sliding contact with the tapered portion 94 of the wedge 30. The gripper outer surface 106 includes a plurality of grooves 108 and a plurality of gripping features 112. In the illustrated embodiment, the grippers 34 include four grooves 108. In other embodiments, the grippers 34 may include fewer or more grooves 108, such as a single groove 108 or more than four grooves 108. In the illustrated embodiment, each of the plurality of grooves 108 extends around the entire circumference of the gripper 34, and all extend a uniform depth into the gripper 34. In other embodiments, the plurality of grooves 108 may only extend partially around the circumference of the gripper 34, and each groove 108 may extend distinct lengths into the gripper 34. At least one of the grooves 108 is configured to receive a biasing member 116, which is configured to apply a radial biasing force to the grippers 34. Additionally, the grooves 108 are configured to receive material build-up from the inner wall of the conduit 11 when the grippers 34 engage the inner wall of the conduit 11. As shown in FIGS. 6A-6B, the plurality of gripping features 112 is knurling formed on the gripper outer surface 106. In the illustrated embodiment, the gripping features 112 are coarse diamond knurling, but in other embodiments, the gripping features may be coarse helical knurling or have alternate knurling geometries. The plurality of gripping features 112 is configured to increase the friction between the grippers 34 and the inner wall of the conduit 11 to inhibit the motion of the mechanical plug 10 within the conduit 11.

FIGS. 6C, 6D, and 6E illustrate a close-up schematic view of alternate gripping features 112C, 112D, 112E respectively. The alternate gripping features 112C, 112D, 112E may either replace or be used in conjunction with the gripping features 112 shown in FIGS. 6A-6B on the gripper outer surface 106.

FIG. 6C illustrates a section of the outer surface 106, which includes the plurality of grooves 108 and a plurality of gripping features 112C. In the illustrated embodiment, the plurality of gripping features 112C includes a plurality of teeth configured to engage the inner wall of the conduit 11 and increase the friction between the grippers 34 and the conduit 11. The increased friction increases the mechanical plug's 10 resistance to motion due to a force applied by fluid flow through the conduit 11. Each tooth comprises an angled face facing away from the direction of fluid flow and a straight face facing in the same direction of fluid flow. The teeth selectively engage the inner wall of the conduit 11 when an axial compressive force is applied to the grippers 34, which increases the friction between grippers 34 and the conduit 11. The increased friction increases the mechanical plug's 10 resistance to motion due to a pressure applied by fluid flow through the conduit 11.

When the mechanical plug 10 is in use and engaged with the conduit 11, the teeth engage the conduit 11 and may also plastically deform depending on the axial compressive force applied to the grippers 34.

FIG. 6D illustrates a section of the outer surface 106, which includes the plurality of grooves 108 and a plurality of gripping features 112D. In the illustrated embodiment, the gripping features 112D are a plurality of balls positioned in the plurality of grooves 108. The balls are configured to engage the inner wall of the conduit 11 when an axial compressive force is applied to the grippers 34, which increases the friction between the grippers 34 and the conduit 11. The increased friction increases the mechanical plug's 10 resistance to motion due to a pressure applied by fluid flow through the conduit 11.

FIG. 6E illustrates a section of the outer surface 106 which includes a plurality of grooves 108 and a plurality of gripping features 112E. In the illustrated embodiment, the gripping feature 112E is a surface finish (e.g., laser etching the surface, applying a high friction coating, or roughening the surface) applied to the gripper outer surface 106. The surface finish is configured to engage the inner wall of the conduit 11 when an axial compressive force is applied to the grippers 34, which increases the friction between the grippers 34 and the conduit 11. The increased friction increases the mechanical plug's 10 resistance to motion due to a pressure applied by fluid flow through the conduit 11.

As shown in FIGS. 3, 7, and 8, the biasing member 116 is positioned within the plurality of grooves 108 of the grippers 34. The biasing member 116 is configured to bias the grippers 34 radially inward towards the wedge 30. In the illustrated embodiment, the biasing member 116 is a garter spring. In other embodiments, the biasing member 116 may be an elastic band or a retaining ring. Also, in the illustrated embodiment, the grippers 34 only receive a single biasing member 116 in one of the grooves 108, but in other embodiments, the grippers 34 may receive more than one biasing member 116 to increase the radial bias on the grippers 34.

In use, an operator inserts the mechanical plug 10 in the disengaged state (FIG. 7) into the conduit 11. Next, the operator positions the mechanical plug 10 at a desired location within the conduit 11. Once positioned in the desired location, the mechanical plug 10 is transitioned to an engaged state (FIG. 8) to maintain the mechanical plug 10 in the desired location.

To transition between the disengaged state and the engaged state, the operator torques (i.e., rotates) the fastener 55 to apply an axial compressive force to the second plug member 22.

The axial compressive force is transferred from the second plug member 22 to the grippers 34 to move the grippers 34 rearward so the gripper inner walls 102 of each gripper 34 slide along the tapered portion 94 of the wedge 30. As the gripper inner wall 102 of each gripper 34 slides along the tapered portion 94, the grippers 34 are moved radially outward against the biasing force of the biasing member 116 until the gripping features 112 engage the inner wall of the conduit 11 to apply a radial force. In some scenarios, the radial force applied by the grippers 34 to the inner wall of conduit 11 plastically deforms the gripping features 112 and/or the inner wall of the conduit 11. In further scenarios, while moving radially outward, the gripper outer surfaces 106 of the grippers 34 may come into contact with material build-up within the conduit 11, and the radial force applied by the grippers 34 disperses the material build-up into the plurality of grooves 108. Dispersing the material build-up enables the grippers 34 to establish improved contact with the inner wall of the conduit 11, which increases the friction between the mechanical plug 10 and the conduit 11. The contact between the grippers 34 and the inner wall of the conduit 11 increases the friction between the conduit 11 and the mechanical plug 10, thus inhibiting the motion of the mechanical plug 10 in the conduit 11.

In the disengaged state (FIG. 7), each of the first plug member 14 and the wedge 30 applies a first axial force on a respective one of the seals 46. The first axial force may be a zero or non-zero value. As such, another result of the axial compressive force applied to the second plug member 22 is an axial compressive force applied to the wedge 30 through the grippers 34. The axial compressive force applied to the wedge 30 results in a reduction in distance between the first engagement surface 42 and the second engagement surface 98, which compresses the seals 46. As a result, the outer diameter of seal 46 increases until the seals 46 engage the inner wall of the conduit 11. The contact between the inner wall of the conduit 11 and the seals 46 inhibits fluid flow past the seals 46. In the engaged state (FIG. 8), each of the first plug member 14 and the wedge 30 applies a second axial force on a respective one of the seals 46 that is greater than the first axial force. Additionally, the seals 46, in conjunction with the grippers 34, increase the friction between the conduit 11 and the mechanical plug 10, thus inhibiting the motion of the mechanical plug 10 in the conduit 11. Once both the seals 46 and the grippers 34 engage the inner wall of the conduit 11, the mechanical plug 10 will be considered to be in the engaged state (FIG. 8).

Once in the engaged state, the position of the mechanical plug 10 within the conduit 11 is limited along with the fluid flow through the conduit 11. To transition back from the engaged state to the disengaged state, the operator applies a loosening torque to the fastener 55, which increases the axial distance between the second plug member 22 and the fastener 55. Simultaneously, the compressive axial force applied to the second plug member 22 is reduced. Once the compressive axial force falls below a threshold, the biasing force of the biasing member 116 moves the grippers 34 radially inward toward the elongate member 18. The radial movement of the grippers 34 also results in axial movement of grippers 34 guided by the contact between the gripper inner wall 102 and the tapered portion 94 of the wedge 30. Axial movement of the grippers 34 results in forward axial movement of the second plug member 22 until the washer 56 contacts the fastener 55.

Another result of the compressive axial force falling below a threshold is the reduction in the axial compressive force applied to the wedge 30. As a result, the distance between the first engagement surface 42 and the second engagement surface 98 increases, and

the seals 46 are no longer compressed. When the seals 46 are no longer compressed, the outer diameter of the seals 46 decreases, and the seals 46 no longer contact the inner wall of the conduit 11. As a result, fluid can now flow through the conduit 11 past the seals 46. Once both the seals 46 and the grippers 34 no longer contact the inner wall of the conduit 11, the mechanical plug 10 will be considered to be in the disengaged state (FIG. 7) and may be moved within and removed from the conduit 11.

Various features and advantages of the disclosure are set forth in the following claims.

What is claimed is:

1. A mechanical plug for restricting fluid flow through a conduit, the mechanical plug comprising:
a first plug member;
an elongate member coupled to the first plug member, the elongate member defining a central axis;
a second plug member received on the elongate member, the second plug member moveable axially along the central axis;
a wedge received on the elongate member between the first plug member and the second plug member, the wedge including a wedge outer wall;
a gripper at least partially surrounding the wedge, the gripper movable both axially along the central axis and radially with respect to the central axis to selectively engage the conduit, the gripper including
a gripper outer wall configured to selectively engage the conduit, and
a gripper inner wall configured to engage the wedge outer wall; and
wherein the mechanical plug is transitionable between a first state, in which the mechanical plug is disengaged from the conduit, and a second state, in which the mechanical plug engages the conduit.

2. The mechanical plug of claim 1, wherein the gripper further includes a circumferential groove formed in the gripper outer wall.

3. The mechanical plug of claim 2, further comprising a biasing member received in the circumferential groove.

4. The mechanical plug of claim 1, wherein the gripper further includes a gripping feature configured to increase friction between the gripper of the mechanical plug and the conduit.

5. The mechanical plug of claim 4, wherein the gripping feature includes knurling.

6. The mechanical plug of claim 4, wherein the gripping feature includes teeth.

7. The mechanical plug of claim 4, wherein the gripping feature includes balls.

8. The mechanical plug of claim 4, wherein the gripping feature is a surface finish.

9. The mechanical plug of claim 1, wherein the wedge outer wall of the wedge includes a first outer wall portion having a constant outer diameter and a second outer wall portion having a non-constant outer diameter, and wherein the second outer wall portion is tapered at a taper angle.

10. The mechanical plug of claim 9, wherein the gripper inner wall includes a first inner wall portion having a non-constant outer diameter, wherein the first inner wall portion is in sliding contact with the second outer wall portion of the wedge outer wall, and wherein axial movement and radial movement of the gripper is based on the taper angle of the second portion.

11. The mechanical plug of claim 1, further comprising:
a seal carrier received on the elongate member between the first plug member and the wedge; and
a seal received on the seal carrier, the seal configured to selectively engage the conduit;
wherein the first plug member includes a first engagement surface configured to engage and apply an axial force to the seal; and
wherein the wedge includes a second engagement surface configured to engage and apply an axial force to the seal.

12. The mechanical plug of claim 11, wherein the seal engages the conduit when the mechanical plug is in the second state.

13. A mechanical plug for restricting fluid flow through a conduit, the mechanical plug comprising:
an elongate member defining a central axis;
a plug member received on the elongate member, the plug member moveable axially along the central axis;
a wedge received on the elongate member, the wedge including a wedge outer wall;
a gripper at least partially surrounding the wedge, the gripper moveable both axially along the central axis and radially with respect to the central axis to selectively engage the conduit, the gripper including
a gripper outer wall configured to selectively engage the conduit, and
a gripper inner wall configured to engage the wedge outer wall; and
an actuator positioned on a side of the plug member opposite the gripper, the actuator engageable to apply a force to the gripper through the plug member, thereby engaging the gripper outer wall with the conduit.

14. The mechanical plug of claim 13, wherein the elongate member is threaded, and wherein the actuator is a fastener configured to be threaded along the elongate member to apply an axial compressive force on the gripper through the plug member.

15. The mechanical plug of claim 14, wherein the elongate member includes a first threaded portion and a second threaded portion, wherein the plug member surrounds a portion of the first threaded portion, and wherein the fastener is received on the second threaded portion.

16. The mechanical plug of claim 14, further comprising a washer positioned between the plug member and the fastener, the washer having a greater surface area than the fastener such the washer is configured to increase the surface area with which the fastener applies the axial compressive force to the plug member.

17. A mechanical plug for restricting flow through a conduit, the mechanical plug comprising:
a first plug member;
an elongate member coupled to the first plug member, the elongate member defining a central axis;
a second plug member received on the elongate member, the second plug member moveable axially along the central axis;
a wedge received on the elongate member between the first plug member and the second plug member;
a seal carrier received on the elongate member between the first plug member and the wedge, the seal carrier including a seal receiving portion and an intermediate portion that protrudes from the seal receiving portion; and
a seal received on the seal receiving portion between the intermediate portion and one of the first plug member and the wedge;
wherein the mechanical plug is transitionable between a first state, in which the one of the first plug member and the wedge applies a first axial force on the seal, and a second state, in which the one of the first plug member and the wedge applies a second axial force on the seal that is greater than the first axial force to compress the seal such that the seal engages the conduit.

18. The mechanical plug of claim 17, wherein the seal receiving portion is a first seal receiving portion and the seal is a first seal, the seal carrier further including a second seal receiving portion on an opposite side of the intermediate portion from the first seal receiving portion, the mechanical plug further comprising a second seal received on the second seal receiving portion between the intermediate portion and the other of the first plug member and the wedge.

19. The mechanical plug of claim 17, wherein the seal carrier defines a fluid channel having an opening in the intermediate portion, wherein the second plug member defines an aperture spaced radially from a center of the second plug member, the mechanical plug further comprising a bypass assembly configured to place the fluid channel and the aperture in second plug member in fluid communication with each other.

20. The mechanical plug of claim 19, wherein the bypass assembly extends through the second plug member and provides a channel for fluid to travel between the seal carrier and a position external to the mechanical plug.
